(19) United States
(12) Patent Application Publication
(10) Pub. No.: US 2026/0239237 A1
(43) Pub. Date: Aug. 13, 2026

(54) UPLINK PERFORMANCE IMPROVEMENT IN ULCA SCENARIOS

(71) Applicant: QUALCOMM Incorporated, San Diego, CA (US)

(72) Inventors: Anuj VYAS, San Diego, CA (US); Deepak VOMMI, San Marcos, CA (US); Yashesh ZAVERI, San Diego, CA (US); Srividhya SHANMUGAM, San Diego, CA (US); Neeraj PANWAR, San Diego, CA (US)

(21) Appl. No.: 19/051,034

(22) Filed: Feb. 11, 2025

(51) Int. Cl. H04W 52/42; H04W 72/0453; H04W 72/21

(52) U.S. Cl. CPC H04W 52/42; H04W 72/0453; H04W 72/21

(57) ABSTRACT

In an aspect of the disclosure, a method, a computer-readable medium, and an apparatus are provided. The method for wireless communication at a user equipment (UE), comprising receiving an uplink carrier aggregation (ULCA) configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and transmitting a non-overlapping uplink transmission on the first carrier, wherein the non-overlapping uplink transmission has a transmission power based on a single carrier maximum power for the first carrier.

### TECHNICAL FIELD

The present disclosure relates generally to communication systems and, more specifically, to wireless communication systems with uplink carrier aggregation (ULCA).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later telecommunication technologies may be based on aspects of 5G NR. There exists a need for further improvements in 5G NR and future telecommunication technology, such as 6G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to receive an uplink carrier aggregation (ULCA) configuration for at least a first carrier and an uplink-capable secondary carrier. At least one of the first carrier or the uplink-capable secondary carrier supports a higher power class than a ULCA power class constraint imposed on a band combination of the first carrier and the uplink-capable secondary carrier. The at least one processor is further configured to transmit a non-overlapping uplink transmission on the first carrier. The non-overlapping uplink transmission has a transmission power based on a single carrier maximum power for the first carrier.

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to transmit, to a UE, a ULCA configuration for at least a first carrier and an uplink-capable secondary carrier. At least one of the first carrier or the uplink-capable secondary carrier supports a higher power class than a ULCA power class constraint imposed on a band combination of the first carrier and the uplink-capable secondary carrier. The at least one processor is further configured to receive, from the UE, a non-overlapping uplink transmission on the first carrier. The non-overlapping uplink transmission has a transmission power based on a single carrier maximum power for the first carrier.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating various types of carrier aggregation, in accordance with various aspects of the present disclosure.

FIG. 5 is a diagram illustrating overlapping and non-overlapping uplink transmissions in an ULCA scenario, in accordance with various aspects of the present disclosure.

FIG. 6A is a plot illustrating the UL transmission power class in single carrier without the ULCA scenario.

FIG. 6B is a plot illustrating the UL transmission power class in non-overlapping UL transmissions according to existing ULCA configurations.

FIG. 7 is a diagram illustrating example of an improved ULCA configuration, in accordance with various aspects of the present disclosure.

FIG. 8 is a plot illustrating the UL transmission power class in non-overlapping UL transmissions according to the improved ULCA configuration, in accordance with various aspects of the present disclosure.

FIG. 9 is a call flow diagram illustrating example of an improved ULCA configuration, in accordance with various aspects of the present disclosure.

FIGS. 10A and 10B are flowcharts of methods of wireless communication at a UE, in accordance with various aspects of the present disclosure.

FIGS. 11A and 11B are flowcharts of methods of wireless communication at a UE, in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

In wireless communication, uplink carrier aggregation (ULCA) allows a user equipment (UE) to transmit data using multiple uplink carriers (e.g., frequency resources or component carriers) simultaneously, thereby improving uplink throughput and spectral efficiency. By configuring a UE to use an aggregation of multiple component carriers, ULCA enables higher data rates to be achieved and optimized network resource utilization, particularly in scenarios where a single uplink carrier may not provide sufficient bandwidth to meet throughput demands, such as cloud gaming, real-time video conferencing, high-resolution content uploads, industrial automation, and vehicular communications (e.g., V2X applications), among other examples. When applying ULCA, the UE receives a configuration for a primary component carrier (PCC) and one or more secondary component carriers (SCCs) that may be aggregated to enable higher data rates, enhanced spectral efficiency, and improved user experience.

The UL transmission power may be capped or limited based on various scenarios. As an example, the UE may be configured with one or more parameters that limit the transmission power that the UE may use for uplink transmission. For example, the UE may receive an radio resource control (RRC) configuration of one or more over-the-air (OTA) parameters that affect the transmission power that the UE may use, such as p-Max, p-NR-FR1, and/or p-UE-FR1, among other examples. The parameters indicate the maximum transmit power fora UE to use in a given cell, cell group, frequency range and/or network configuration. In some aspects, there may be power constraints based on UE power classes that define a maximum output power for any transmission bandwidth within a channel bandwidth of carrier. As an example, power limitations for a power class may be defined in a wireless standard. As an example for NR, power class constraints associated with a given ULCA band combination are defined in 3GPP TS 38.101 for example, and indicate a maximum permissible transmit power when multiple component carriers are aggregated for uplink transmission. The aspects presented herein are not limited to 5G NR, and may be applicable to other technologies such as 6G or others. The power class constraints also influence UL power limitations, even when only a single carrier is active.

In some aspects, a UE may be allowed to use a transmission power above the ULCA band power class. For example, a UE may indicate support for a higher power limit capability, such as in RRC capability signaling. In some aspects, the capability may be referred to as a “higherpowerlimit” or “higherpowerlimit-r17,” among other examples. The feature may allow the UE to override the defined ULCA power class limit for a specific band combination, enabling the UE to use a higher transmission power. For example, in a frequency-division duplex (FDD)+time-division duplex (TDD) or TDD+FDD ULCA configuration, the power class may correspond to Power Class (PC) 2, but the combined power may exceed the PC2 limit, reaching 27 dBm or 28 dBm, depending on e.g., maximum power reduction (MPR), additional power reduction (APR), and Delta_PC adjustments. The use of UL power limitations and/or defined power constraints for various ULCA band combinations, even when a UE may support a higher power class for a single band/carrier (e.g., such as PC 1.5, which allows transmit power up to 29 dBm) can lead to signal degradation in some scenarios. Aspects presented herein enable higher power configurations or higher UL transmission power under some conditions, such as for UEs that support the capability and/or for non-overlapping transmissions, UEs may be configured with ULCA and may determine a transmission power based on a single carrier.

Various aspects of the present disclosure relate generally to wireless communication and, more specifically, to enhancements in uplink transmission for ULCA scenarios. In particular, the present disclosure enables determination of uplink transmission power based on whether the transmission is overlapping or non-overlapping. If the uplink transmission on a single carrier is non-overlapping (e.g., does not overlap in time with a transmission on an additional carrier), the UE may determine the transmission power based on the single-carrier maximum power rather than being constrained by the ULCA power class limit, in some aspects. More specifically, when performing ULCA on a first carrier (e.g., the PCC and or one of the SCCs) and one or more uplink-capable secondary carriers (one or more of the SCCs), the UE may signal to the network support for a capability to transmit at a higher power class than the ULCA power class constraint imposed on a band combination for the first carrier and the one or more uplink-capable secondary carriers. In response, the network may configure a ULCA configuration accordingly. Based on this ULCA configuration, the UE may transmit non-overlapping uplink transmissions based on the single-carrier maximum power, while ensuring compliance with regulatory and hardware constraints, such as the maximum allowable transmit power for the first carrier as supported by the UE, the uplink transmission power constraint for the first carrier, and the maximum transmit power limit (MTPL) of the UE.

In some aspects, the UE may receive an ULCA configuration for at least a first carrier and an uplink-capable secondary carrier. The first carrier may support a higher power class than a ULCA power class constraint imposed on a band combination of the first carrier and the uplink-capable secondary carrier. The UE may transmit a non-overlapping uplink transmission on the first carrier, where the non-overlapping uplink transmission has a transmission power based on a single carrier maximum power for the first carrier.

In some aspects, the transmission power may be based on the single carrier maximum power for the first carrier based on a condition that the non-overlapping uplink transmission on the first carrier does not overlap in time with an additional transmission on the uplink-capable secondary carrier.

In some aspects, the transmission power of the non-overlapping uplink transmission may further be based on a maximum transmit power limit (MTPL) of the UE.

In some aspects, the single carrier maximum power for the first carrier may be based on a maximum allowable transmit power for the first carrier as supported by the UE and an uplink transmission power class constraint for the first carrier.

In some aspects, the single carrier maximum power for the first carrier may be determined as a minimum of the maximum allowable transmit power for the first carrier as supported by the UE and the uplink transmission power class constraint for the first carrier.

In some aspects, the UE may transmit two or more overlapping uplink transmissions on at least the first carrier and the uplink-capable secondary carrier simultaneously, where transmission powers for the two or more overlapping uplink transmissions are based on the ULCA power class constraint applicable to the band combination of the first carrier and the uplink-capable secondary carrier.

In some aspects the UE may transmit a message indicating whether the UE supports transmitting the non-overlapping uplink transmission on the first carrier based on the single carrier maximum power for the first carrier.

In some aspects, the message may be indicated in a radio resource control (RRC) information element (IE).

Particular aspects of the subject matter described in this disclosure can be implemented to realize one or more of the following potential advantages. In some examples, by determining a transmission power for non-overlapping uplink transmissions based on the single-carrier maximum power rather than the ULCA power class limit, the described techniques can be used to allow for increased UL transmission power under certain conditions and to optimize uplink transmission efficiency while ensuring compliance with network-imposed and regulatory constraints. The disclosed techniques may also improve the ULCA performance, reduce power restrictions based on meeting certain conditions, and enhance overall network efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems or others such as 6G, may be arranged in multiple manners with various components or constituent parts. Some aspects may be discussed in connection with 5G NR to illustrate the concept, but are not limited to 5G NR and may be applied in connection with additional technologies, such as 6G. In a wireless communication system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

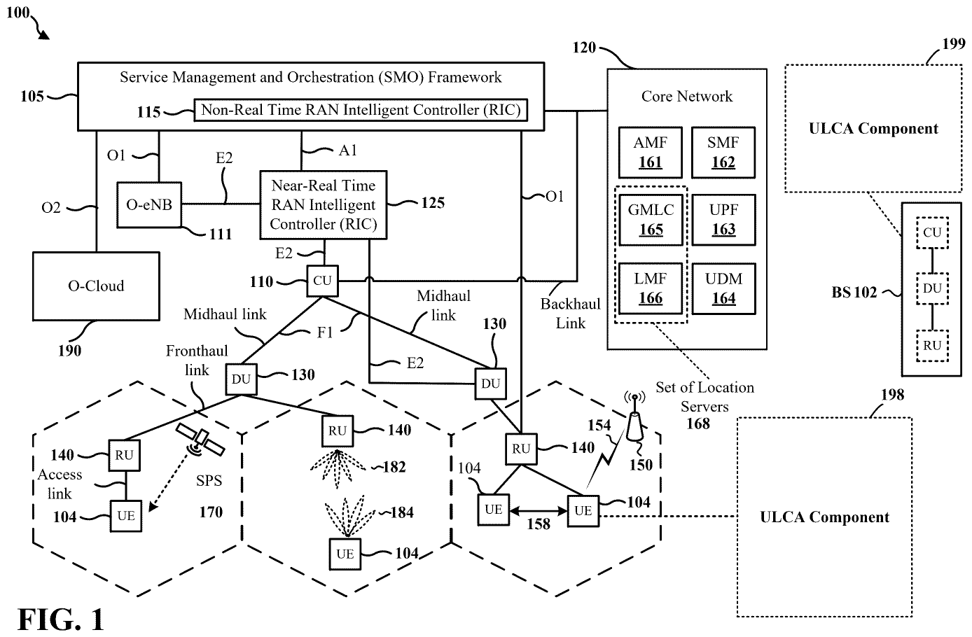

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, for example two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands may be explored to extend operation beyond 52.6 GHz. For example, three higher operating bands have been identified as frequency range designations FR2-2 (52.6 GHZ-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to receive a ULCA configuration for at least a first carrier and an uplink-capable secondary carrier, where the first carrier supports a higher power class than a ULCA power class constraint imposed on a band combination of the first carrier and the uplink-capable secondary carrier, and transmit a non-overlapping uplink transmission on the first carrier, where the non-overlapping uplink transmission has a transmission power based on a single carrier maximum power for the first carrier. In certain aspects, the base station 102 may have a component 199 that may be configured to transmit, to a UE, a ULCA configuration for at least a first carrier and an uplink-capable secondary carrier, where the first carrier supports a higher power class than a ULCA power class constraint imposed on a band combination of the first carrier and the uplink-capable secondary carrier, and receive, from the UE, a non-overlapping uplink transmission on the first carrier, where the non-overlapping uplink transmission has a transmission power based on a single carrier maximum power for the first carrier. The technical solutions disclosed herein allow the UE to fully utilize the single-carrier maximum power when transmitting only on a signal active carrier, rather than being unnecessarily constrained by the lower ULCA power class limit intended for multiple simultaneously active carriers.

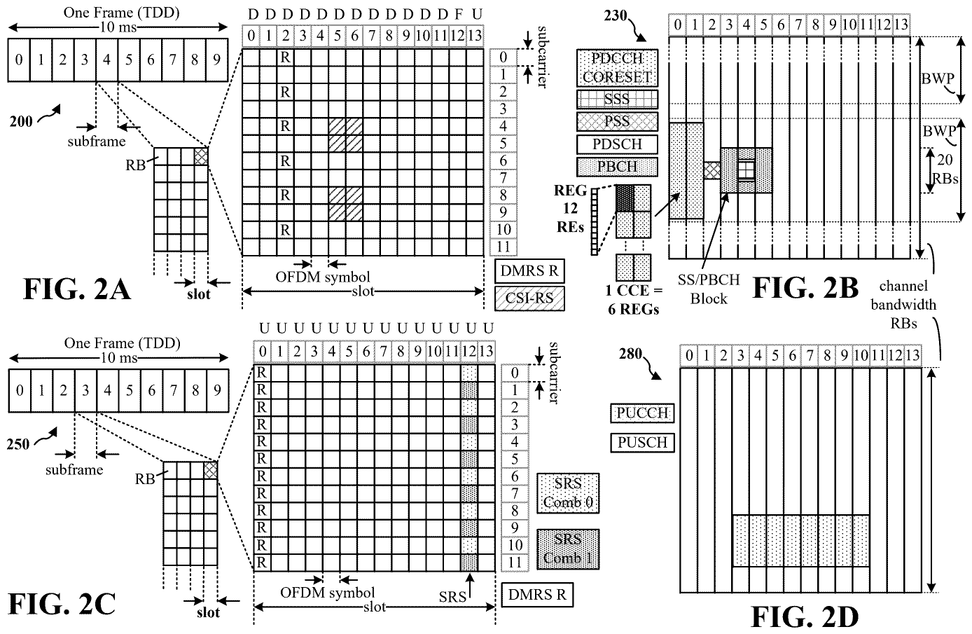

Wireless communication may be based on a frame structure having time and frequency resources. Example aspects are described in connection with 5G NR to illustrate the concept of a frame structure. Various aspects may also be applied in connection with other wireless communication technologies. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

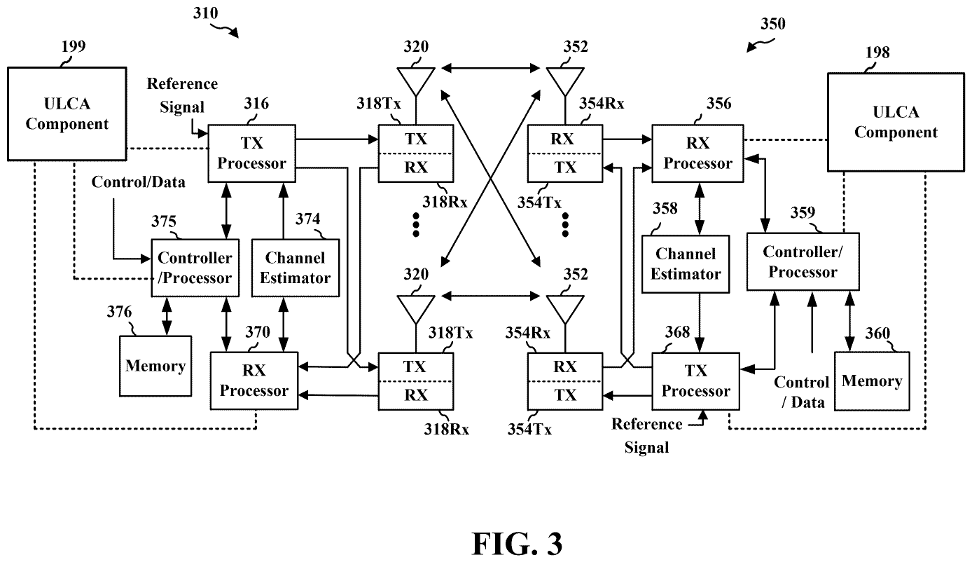

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ULCA component 198 of FIG. 1.

At least one of the TX processor 316, the RX processor 370, and the controller/processor 375 may be configured to perform aspects in connection with the ULCA component 199 of FIG. 1.

In wireless communication, ULCA allows a UE to transmit data using multiple uplink carriers simultaneously, thereby improving uplink throughput and spectral efficiency. When applying ULCA, a PCC and one or more SCCs may be aggregated to enable higher data rates, better resource utilization, and improved user experience. ULCA may be applied in scenarios requiring high uplink throughput, such as cloud gaming, video conferencing, and uplink-heavy applications in industrial automation and vehicular communication.

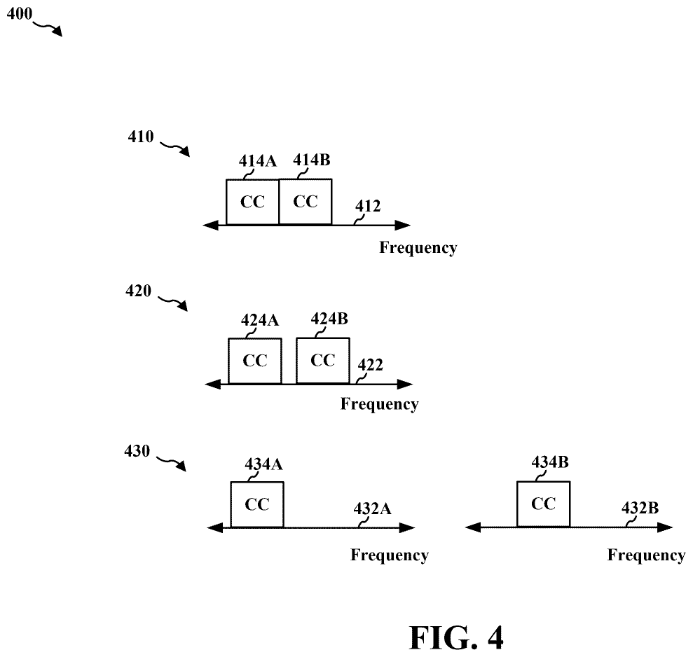

FIG. 4 is a diagram 400 illustrating various types of carrier aggregation. As illustrated in example 410 of FIG. 4, for intra-band aggregation with frequency-contiguous component carriers, in a frequency band 412, two frequency-contiguous component carriers 414A and 414B may be aggregated. As illustrated in example 420 of FIG. 4, for intra-band aggregation with non-contiguous component carriers, in a frequency band 422, two non-contiguous component carriers 424A and 424B may be aggregated. As illustrated in example 430 of FIG. 4, for inter-band aggregation, a component carrier 434A on a first frequency band 432A may be aggregated with a component carrier 434B on a second frequency band 432B.

It is noted that the component carriers illustrated in FIG. 4 may correspond to any of the PCC and/or one or more SCCs, without limitation.

The UL transmission power may be capped or limited based on various scenarios. As an example, the UE may be configured with one or more parameters that limit the transmission power that the UE may use for uplink transmission. For example, the UE may receive an radio resource control (RRC) configuration of one or more over-the-air (OTA) parameters that affect the transmission power that the UE may use. The UE may receive RRC signaling indicating one or more of a maximum transmit power that is allowed for uplink transmissions for a cell or on a carrier frequency (e.g., which may be referred to as p-Max,) a maximum transmit power for uplink transmissions to a cell group (e.g., a group of one or more cells), and/or a maximum transmit power for uplink transmissions for a total of all serving cells operating on a frequency range. As an example, the maximum transmit power for the cell group may be associated with a frequency range. As an example, the parameter may be referred to as p-NR-FR1, which indicates a maximum transmit power for use by the UE in a cell group across all serving cells in FR1. In some aspects, a similar parameter may be configured for cell groups in other frequency ranges, such as FR2. The maximum transmit power for uplink transmissions for a total of all serving cells operating on a frequency range (e.g., across all cell groups) may be referred to as p-UE-FR1, in an example for FR1. A similar parameter may be configured for other frequency ranges, such as FR2. In some aspects, p-Max may correspond to a maximum transmit power for transmissions to a serving cell. The parameters indicate the maximum transmit power fora UE to use in a given cell, cell group, frequency range and/or network configuration.

In some aspects, there may be power constraints based on UE power classes that define a maximum output power for any transmission bandwidth within a channel bandwidth of carrier. As an example, power limitations for a power class may be defined in a wireless standard. As an example for NR, power class constraints associated with a given ULCA band combination are defined in 3GPP TS 38.101 for example, and indicate a maximum permissible transmit power when multiple component carriers are aggregated for uplink transmission. The power class constraints also influence UL power limitations, even when only a single carrier is active.

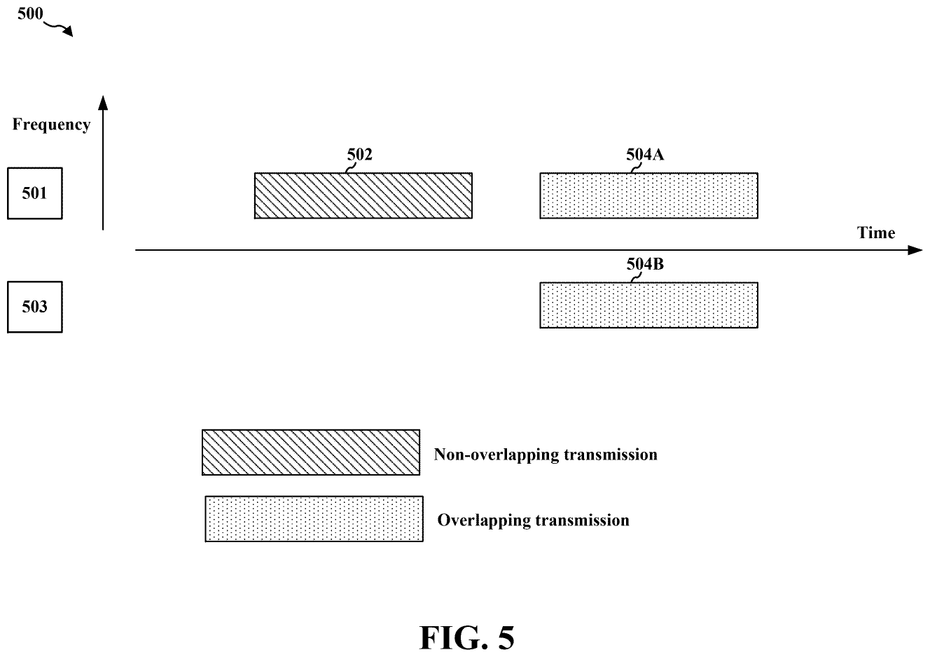

FIG. 5 is a diagram 500 illustrating examples of overlapping and non-overlapping uplink transmissions in an ULCA scenario, in accordance with various aspects of the present disclosure. Based on the ULCA configuration, a UE capable of transmitting uplink transmissions on a PCC and one or more SCCs may operate in different transmission conditions: (i) non-overlapping uplink transmission, where the UE transmits on only one uplink carrier at a time, and (ii) overlapping uplink transmission, where multiple uplink carriers are used simultaneously.

As shown in FIG. 5, a non-overlapping uplink transmission 502 may correspond to an uplink transmission on a first carrier 501 that does not temporally overlap with an additional transmission on other carriers (e.g., an uplink-capable secondary carrier 503). For example, in this scenario, the UE may transmit uplink transmission 502 only on the PCC or on one of the one or more SCCs at any given time, without simultaneous transmission occurring on other carriers (e.g., PCC or SCCs).

Overlapping uplink transmissions 504A and 504B may correspond to uplink transmissions where the UE transmits on the first carrier 501 and one or more uplink-capable secondary carriers (e.g., at least one uplink-capable secondary carrier 503) simultaneously. For example, the UE may transmit uplink transmission 504A and 504B concurrently on more than one carrier (e.g., PCC and at least one SCC) at a given time.

The ULCA power class constraint provides the maximum allowable transmission power when multiple uplink carriers are active simultaneously. The ULCA power class constraint may help regulate the total uplink power across all aggregated carriers, ensuring compliance with network and regulatory limits while minimizing interference.

According to existing ULCA configurations, the ULCA power class constraint for combined carriers applies to uplink transmissions even when the UE is transmitting using only a single carrier. That is, in ULCA scenarios, when only one carrier is active, the UE remains restricted by the ULCA power class constraint, even if the single-carrier maximum power for the active carrier (e.g., the carrier where the network is scheduling uplink data) is higher than the ULCA-imposed limit for the combined band. As a result, ULCA power control may prevent the UE from utilizing the full transmission power available for a single carrier when SCCs are inactive, potentially leading to suboptimal uplink performance.

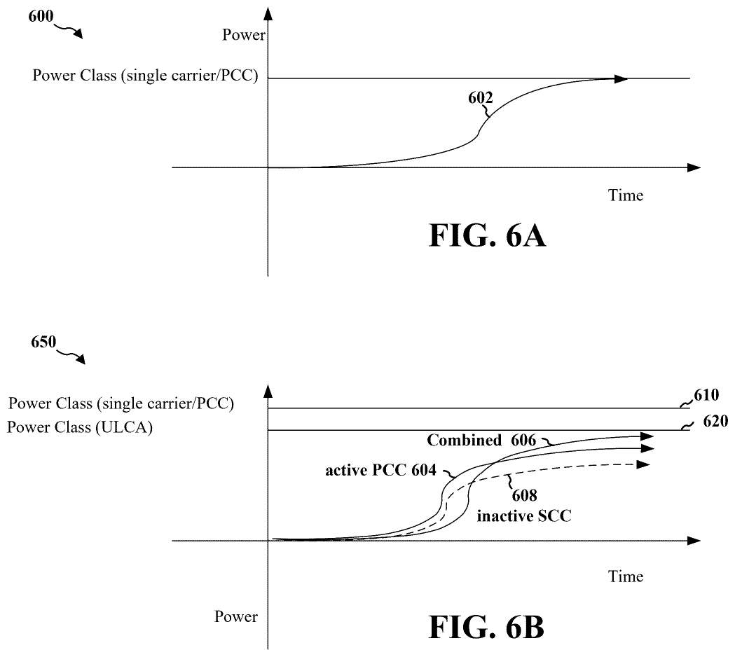

FIG. 6A is a plot 600 illustrating the UL transmission power class in single carrier without ULCA. When the UE transmits on only one carrier without ULCA, the uplink transmission power (curve 602) is capped by the single-carrier maximum power constraint applicable to the active carrier. Accordingly, the UE may not exceed the single-carrier maximum power limit, e.g., which may be based on regulatory and/or hardware constraints. As an example of a hardware constraint, if the UE supports a maximum single-carrier transmission power of 26 dBm, the UE does not transmit uplink signals beyond this level.

When a UE operates in a ULCA scenario, the uplink transmission power is further based on the ULCA power class constraint, e.g., in addition to the single-carrier transmission power limits. Thus, even when only one carrier is active, the ULCA power class constraint for the combined carriers applies, preventing the UE from utilizing the potentially higher power levels allowed in a single-carrier transmission scenario.

FIG. 6B is a plot 650 illustrating the UL transmission power class for UL transmissions according to existing ULCA configurations. In existing ULCA implementations, when the UE transmits a non-overlapping UL transmission, the ULCA power class constraint for the combined carriers (e.g., 620) applies, even if only one carrier is active. For example, if the ULCA power class constraint (e.g., 620) for a specific band combination may be 23 dBm, while the single-carrier maximum power (e.g., 610) for the active carrier may be 26 dBm, the uplink transmission power for the UE remains restricted to 23 dBm based on UCLA, even when the UE is transmitting on only one carrier. As shown in FIG. 6B, the combined uplink transmission power (curve 606)—accounting for the active PCC with a transmission power of (curve 604) and the inactive SCC with a transmission power of (curve 608)—may still be capped by the ULCA power class constraint (e.g., 620) for the combined band, even when the SCC is inactive.

Thus, under existing ULCA configurations, the UE may be unable to fully utilize the available power of the active carrier due to the ULCA power class constraint even in non-overlapping transmission scenarios.

In one example, the PCC may support up to 26 dBm (e.g., PCC=Power Class 2 (PC2) (26 dBm)) and the SCC may support up to 23 dBm (e.g., SCC=PC3 (23 dBm)). However, based on an ULCA power constraint, the total UE maximum for the power band combination may be limited as 23 dBm (e.g., UE Max Power=23 dBm). As a result, even though the UE may theoretically transmit at 26 dBm on the PCC, the ULCA power class constraint restricts the UE's maximum power to 23 dBm.

For a further example, the PCC may support up to 26 dBm (e.g., PCC=PC2 (26 dBm)), the SCC may support up to 26 dBm (e.g., SCC=PC2 (26 dBm)), and the UE maximum power may be limited based on 23 dBm. Although, both the PCC and SCC may support up to 26 dBm transmission power (PC2), the actual UE maximum power may instead be determined by the specific band combination limit for ULCA, which may be lower than the single-carrier maximum power for the active carrier.

In another example, in a configuration where the PCC is in TDD mode with PC2 and the SCC is in FDD mode with PC3 (e.g., PCC/TDD (PC2)+SCC/FDD (PC3)=T+F ULCA (PC3)), the activation of the SCC may cause the PCC to comply with the ULCA power class constraint. As a result, once an SCC is added or activated for ULCA for the UE, the UE may no longer transmit at the higher power level (e.g., PC2) on the PCC that could be use in a single-carrier scenario. Instead, the UE transmissions on the PCC are restricted to PC3, even when the SCC is inactive or when transmissions on PCC and SCC are non-overlapping.

Therefore, aspects presented herein provide improved determinations of uplink transmission power for ULCA configurations that improve uplink coverage and performance, particularly in scenarios where a higher single-carrier power can be utilized. As the ULCA envelope expands to include multiple bands and wider bandwidths, the aspects presented herein enable improved transmission power determinations in ULCA scenarios for a given band combination to allow use of the maximum transmission power of the UE. For example, the aspects presented herein may improve the accurate reception of UL transmissions in poor signal conditions such as at the cell edge, where the UE is transitioning between cells- and has an ULCA configuration. The aspects presented herein enable the UE to fully utilize the higher transmission power supported by individual carriers.

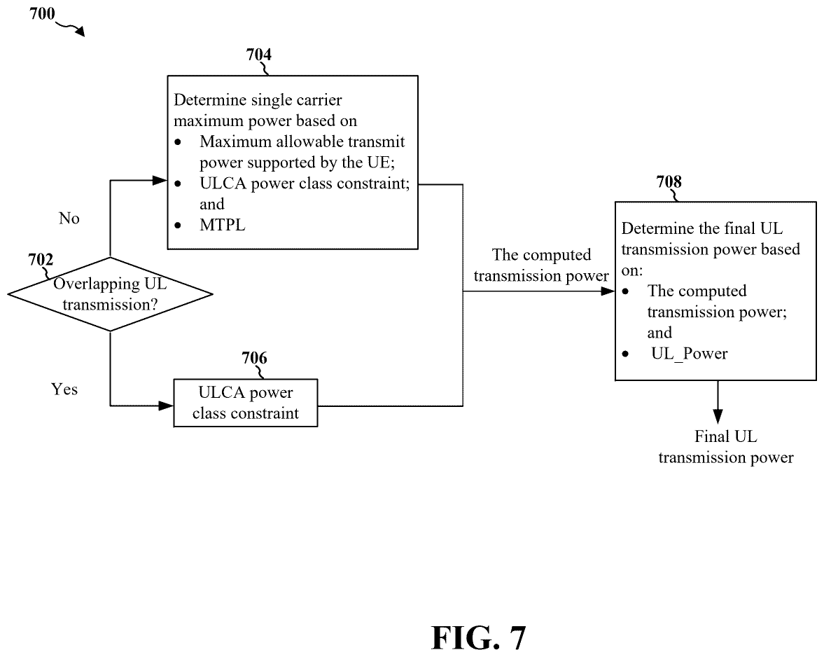

FIG. 7 is a diagram illustrating an example of an improved UL transmission power determination 700 for a UE with an ULCA configuration, in accordance with various aspects of the present disclosure. The UE may be configured to transmit uplink transmissions on a first carrier and one or more uplink-capable secondary carriers based on an ULCA configuration. The first carrier and the uplink-capable secondary carriers may correspond to any of the PCC or SCCs of the UE. For example, the first carrier may be the PCC or an uplink capable SCC.

When the UE is configured to transmit an uplink transmission on a first carrier, at 702, the UE may determine whether the uplink transmission overlaps in time with an additional transmission on an uplink-capable secondary carrier, e.g., whether the uplink transmission is an overlapping uplink transmission or a non-overlapping uplink transmission.

If the uplink transmission is non-overlapping, the UE may apply the single-carrier maximum power for the active carrier where network is scheduling uplink data as the computed transmission power. For example, at 704, the computed transmission power may be determined as the maximum among:
1. The maximum allowable transmit power supported by the UE,
2. The ULCA power class constraint imposed on the band combination of the first carrier and the uplink-capable secondary carrier, and
3. The maximum transmit power limit (MTPL) of the UE.

If the first carrier supports a higher power class than the ULCA power class constraint—for example, if the maximum allowable transmit power on the first carrier supported by the UE exceeds the ULCA power class constraint—then the ULCA power class constraint may be overridden by the higher maximum allowable transmit power. The UE may then compare the maximum allowable transmit power on the first carrier supported by the UE with the MTPL, and the higher of the two values may be applied as the computed transmission power level.

If the uplink transmission is overlapping, at 706, the UE may apply the ULCA power class constraint imposed on the band combination of the first carrier and the uplink-capable secondary carrier as the computed transmission power.

At 708, the computed transmission power may be compared with an uplink transmission power limit for the first carrier (e.g., UL_power), which may be dynamically determined based on the network conditions, to ensure that the final uplink transmission power selected for the UE complies with network-indicated parameters. Specifically, the final uplink transmission power may be determined as the minimum of:
1. The computed transmission power, which accounts for the maximum allowable transmit power supported by the UE, the ULCA power class constraint, and the MTPL; and
2. UL_power, which corresponds to a network-imposed uplink power limit based on network conditions.

Applying the improved transmission power determination for a UE having an ULCA configuration may enhance uplink transmission efficiency by allowing the UE to utilize a higher transmission power in non-overlapping uplink transmission scenarios. By dynamically adjusting the uplink transmission power based on whether the transmission is overlapping or non-overlapping, the ability or use a higher UL transmission power optimizes uplink performance in scenarios where a higher single-carrier power could otherwise be used but exceeds ULCA power class constraints. For example, the improved UL power determination may enhance the uplink performance in challenging network environments, such as cell-edge conditions, where signal degradation may benefit from higher transmission power to maintain link reliability and coverage.

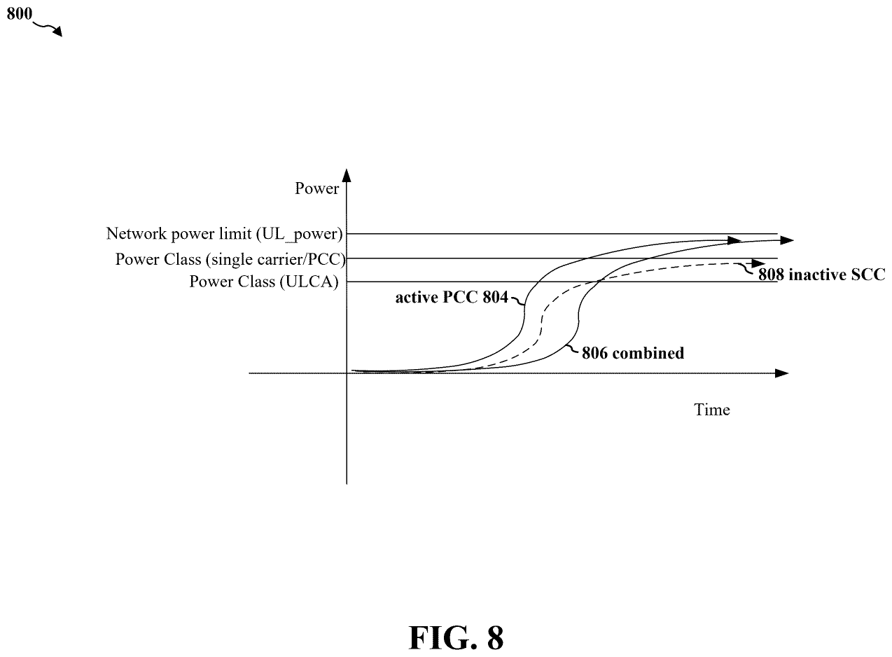

FIG. 8 is a plot 800 illustrating the UL transmission power class in non-overlapping UL transmissions according to the transmission power determinations presented herein, in accordance with various aspects of the present disclosure. As shown in FIG. 8, the improved transmission power determination allows the UE configured for ULCA to transmit at a higher power level for a single carrier in non-overlapping uplink transmission scenarios, compared to use of transmission power limits based on ULCA power class constraints. Unlike FIG. 6B, where the ULCA power class constraint for combined carriers still applies to a single active carrier, FIG. 8 illustrates that the UE can leverage the full single-carrier transmission power when only one (e.g., a single) carrier is active (e.g., for non-overlapping transmission).

In particular, curve 804 represents the uplink transmission power of the active PCC, while curve 808 represents the inactive SCC in the non-overlapping scenario. The combined transmission power is indicated by curve 806. As presented herein, when the SCC is inactive, the UE may be transmit at a higher power level using the PCC (or an uplink capable SCC), subject to single-carrier maximum power constraints instead of the ULCA power class constraint for aggregated carriers. Although an example is illustrated using PCC to illustrate the concept, the combination may be for UL transmission on an uplink capable SCC in a non-overlapping manner, and the second CC may be an additional SCC.

For example, if transmission power is limited based on ULCA combination, if the ULCA power class constraint for a specific band combination was 23 dBm, but the single-carrier maximum power for the active PCC (or UL capable SCC) was 26 dBm, the UE was restricted to 23 dBm even when only transmitting on the PCC (or UL capable SCC). However, as presented herein, the UE may transmit at 26 dBm in non-overlapping scenarios, leading to enhanced uplink coverage and performance.

The transmission power determination presented herein allows the UE to fully utilize the single-carrier maximum power when transmitting on a signal active carrier, rather than being constrained by a lower ULCA power class limit that may be applied instead for multiple simultaneously active carriers.

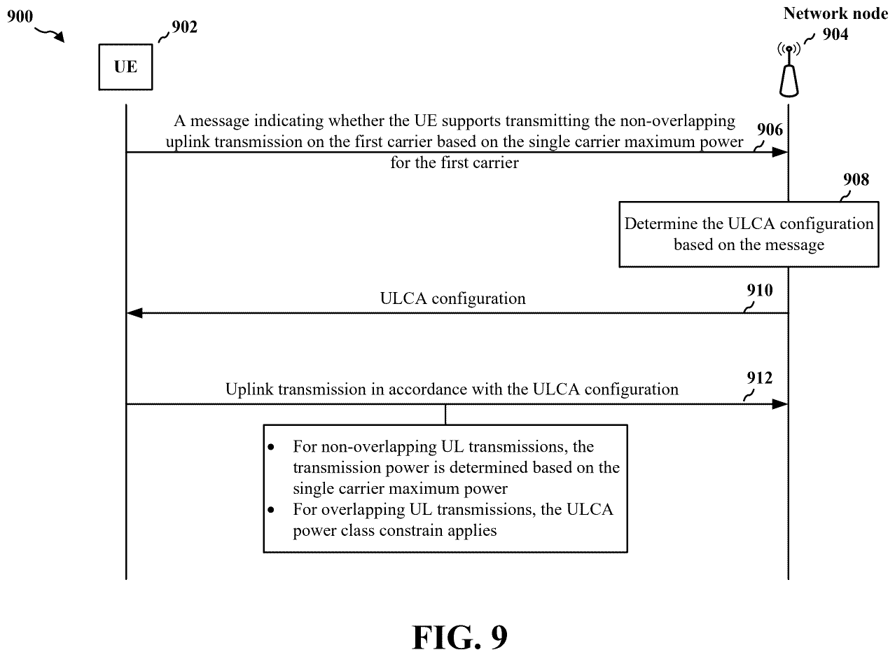

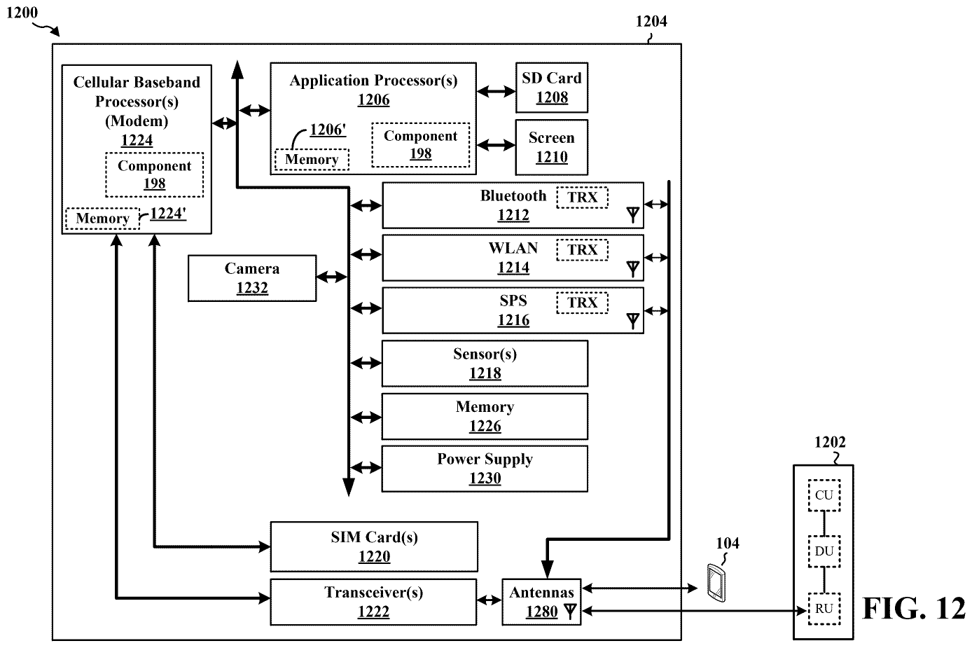

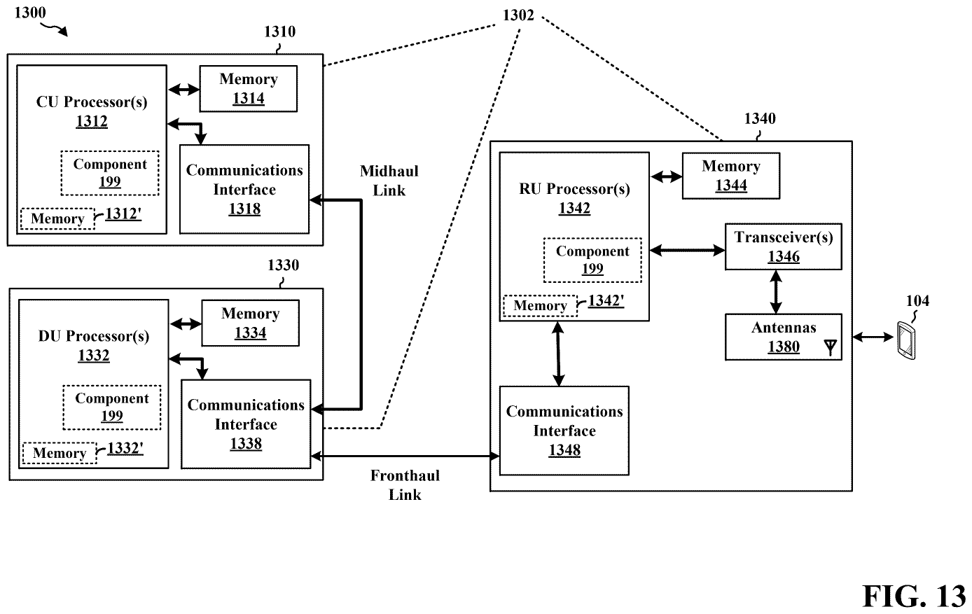

FIG. 9 is a call flow diagram 900 illustrating example of an improved transmission power determination for a UE configured for ULCA, in accordance with various aspects of the present disclosure. The example call flow diagram 900 may be performed between a UE 902 and a network node 904. In some aspects, the UE 902 may correspond to the UE 104 in FIG. 1, the UE 350 in FIG. 3, or the apparatus 1204 in the hardware implementation of FIG. 12. The network node 904 may correspond to the base station 102 in aggregation and/or by one or more components (e.g., such as a CU 110, a DU 130, and/or an RU 140) in FIG. 1, the base station 310 in aggregation and/or by one or more components in FIG. 3, or the network entity 1302 in the hardware implementation of FIG. 13. In some aspects, the network node 904 may also correspond to a network entity in the core network 120 in FIG. 1. The communication may include any of the aspects described in connection with FIGS. 7 and 8.

At 906, the UE 902 may transmit to the network node 904 a message indicating whether the UE supports transmitting a non-overlapping uplink transmission on a single carrier based on the single carrier maximum power for the corresponding carrier. In some aspects, the message may be part of the UE's RRC capability information and may include an RRC IE for ULCA bands that signals whether the UE supports the capability for using a single carrier maximum power in ULCA scenarios (e.g., which may be referred to as a per_carrier_max_power_allowed among other examples) is enabled (e.g., “yes” or “no”). In some aspects, the support may be indicated for a particular carrier or carrier combination. In some aspects, the capability may be referred to as an increased transmission capability for ULCA or a capability to override an ULCA power class restriction based on a single carrier maximum transmission power. Based on the message, the UE 902 may inform the network node 904 whether it is capable of utilizing the single-carrier maximum power in non-overlapping transmission scenarios, overriding the ULCA-based power limitation when a single carrier is active.

At 908, the network node 904 may determine the ULCA configuration based on the message received from the UE 902. In some aspects, if the UE 902 indicates that the UE supports transmitting at the single-carrier maximum power in non-overlapping scenarios, the network node 904 may configure the UE with an ULCA configuration (e.g., the transmit power determination discussed in FIG. 7) accordingly. In some aspects, the network node 904 may indicate, e.g., in the configuration, for the UE to use the single-carrier maximum power in non-overlapping conditions. In some aspects, once the network decodes the capability information, the network node may be aware that when the UE transmits uplink data on a single carrier, the network node 904 may configure the maximum transmission power on the single carrier (m_power), irrespective of the ULCA power class constraint for aggregated carriers.

At 910, the network node 904 may transmit to the UE 902 the ULCA configuration determined at 908. One or more aspects of the ULCA configuration may be based on the UE's capability signaling (e.g., whether the UE supports transmitting non-overlapping uplink transmissions at the single-carrier maximum power). The details of the ULCA configuration may include further aspects discussed with respect to FIG. 7, for example.

At 912, the UE 902 may transmit uplink transmissions in accordance with the ULCA configuration received from the network node 904 and the capability supported by the UE. In some aspects, the UE may determine (e.g., dynamically determine) the transmission power based on whether the uplink transmission is overlapping or non-overlapping:
1. For non-overlapping UL transmissions, the UE may apply a single-carrier maximum power, meaning that the UE may transmit based on the higher power level supported by the first carrier, which may be subject to regulatory constraints (e.g., UL_power, MTPL). For example, if the single-carrier maximum power for the single carrier is 26 dBm, but the ULCA power class constraint for the band combination is 23 dBm, the UE may transmit at 26 dBm when no other carriers are active.
2. For overlapping UL transmissions, the UE may apply the ULCA power class constraint. That is, when the UE transmits on multiple uplink carriers simultaneously, the UE may determine the UL transmission power based on the aggregated power class constraint for the band combination. For example, if the ULCA power class constraint for a band combination of PCC and SCC is 23 dBm, the UE may determine the transmission power to not exceed 23 dBm, even if the PCC alone supports up to 26 dBm.

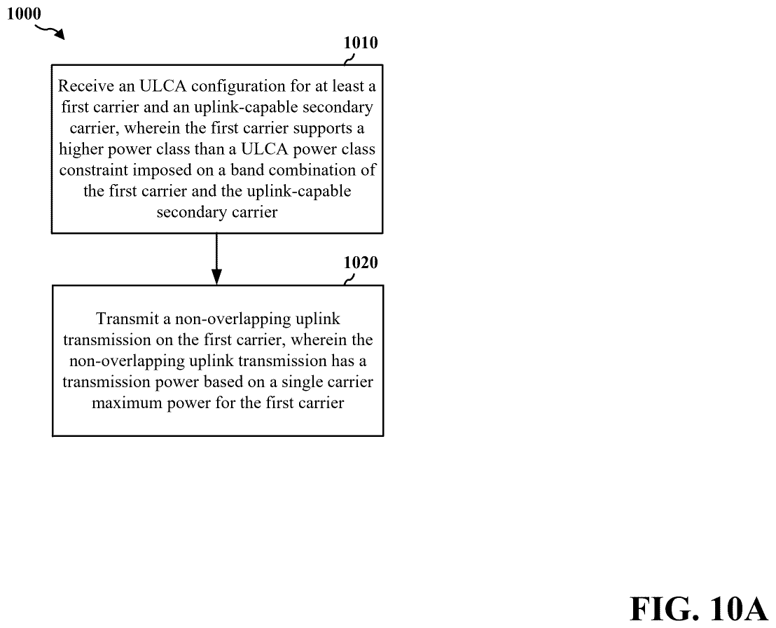

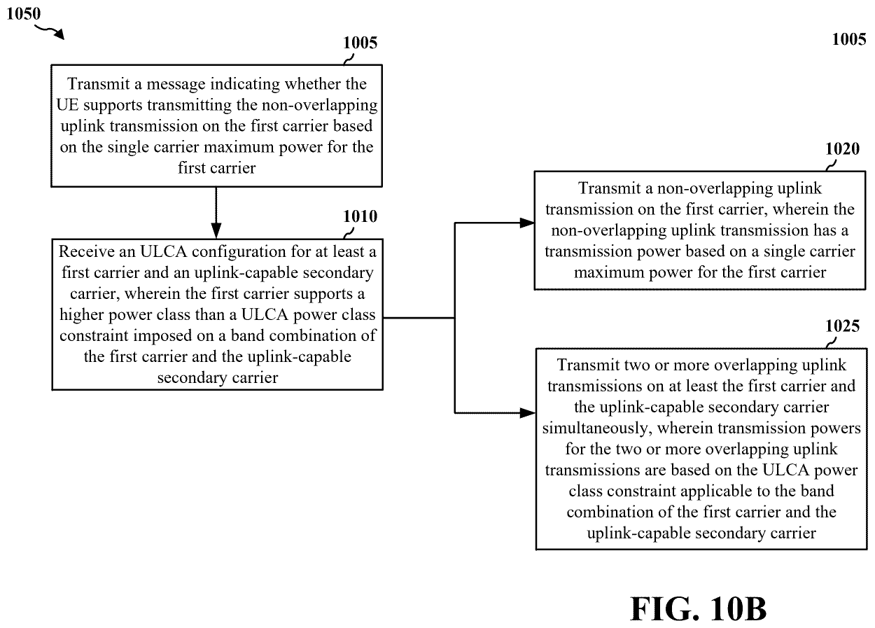

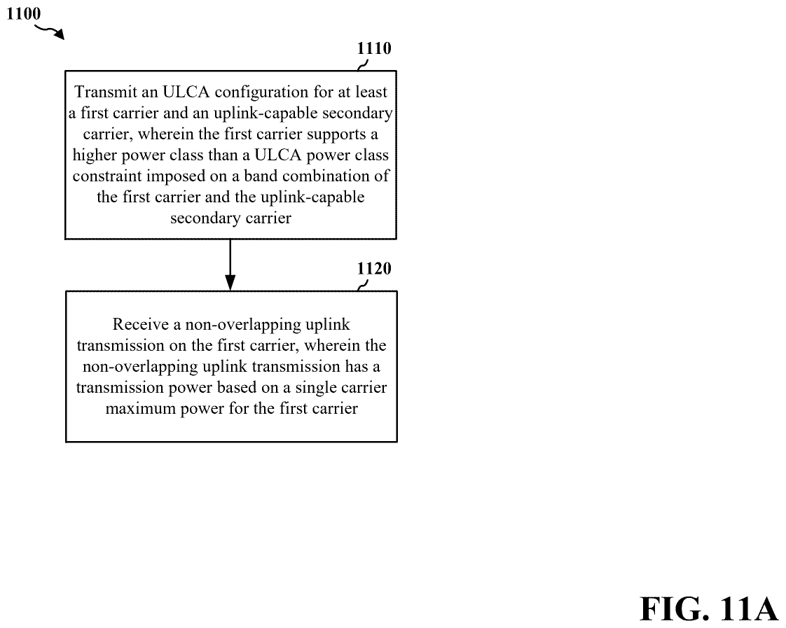

FIG. 10A is a flowchart 1000 of methods of wireless communication at a UE, in accordance with various aspects of the present disclosure. The UE may correspond to the UE 104 in FIG. 1, the UE 350 in FIG. 3, the UE 902 in FIG. 9, or the apparatus 1204 in the hardware implementation of FIG. 12. The method improves the ULCA performance, reduces power restrictions under certain conditions, and enhances the connection stability, particularly in scenarios such as cell-edge conditions.

At 1010, the UE may receive a ULCA configuration for at least a first carrier and an uplink-capable secondary carrier, wherein the first carrier supports a higher power class than a ULCA power class constraint imposed on a band combination of the first carrier and the uplink-capable secondary carrier. FIG. 9 illustrates an example of a UE receiving ULCA configuration, at 910. In some aspects, 1010 may be performed by the ULCA component 198, the transceiver 1222, and/or the antenna 1280 in FIG. 12.

At 1020, the UE may transmit a non-overlapping uplink transmission on the first carrier, where the non-overlapping uplink transmission has a transmission power based on a single carrier maximum power for the first carrier. The transmission may include various aspects described in connection with any of FIGS. 7-9, for example. In some aspects, 1010 may be performed by the ULCA component 198, the transceiver 1222, and/or the antenna 1280 in FIG. 12.

FIG. 10B is a flowchart 1050 of methods of wireless communication at a UE, in accordance with various aspects of the present disclosure. The UE may correspond to the UE 104 in FIG. 1, the UE 350 in FIG. 3, the UE 902 in FIG. 9, or the apparatus 1204 in the hardware implementation of FIG. 12. The method improves the ULCA performance, reduces power restrictions under certain conditions, and enhances the connection stability, particularly in scenarios such as cell-edge conditions. Some aspects of FIG. 10B may be similar to the aspects of FIG. 10A and are shown with the same reference number.

At 1005, the UE may transmit a message indicating whether the UE supports transmitting the non-overlapping uplink transmission on the first carrier based on the single carrier maximum power for the first carrier. In some aspects, message may be indicated in a RRC IE, such as in capability signaling. FIG. 9 illustrates an example of a UE transmitting an indication of support for a capability at 906. In some aspects, 1005 may be performed by the ULCA component 198, the transceiver 1222, and/or the antenna 1280 in FIG. 12.

At 1010, the UE may receive a ULCA configuration for at least a first carrier and an uplink-capable secondary carrier, where the first carrier supports a higher power class than a ULCA power class constraint imposed on a band combination of the first carrier and the uplink-capable secondary carrier. FIG. 9 illustrates an example of a UE receiving ULCA configuration, at 910. In some aspects, 1010 may be performed by the ULCA component 198, the transceiver 1222, and/or the antenna 1280 in FIG. 12.

At 1020, the UE may transmit a non-overlapping uplink transmission on the first carrier, wherein the non-overlapping uplink transmission has a transmission power based on a single carrier maximum power for the first carrier. In some aspects, 1010 may be performed by one or more of the ULCA component 198, the transceiver 1222, and/or the antenna 1280 in FIG. 12. FIGS. 7, 8, and 9 illustrate example aspects in connection with a UE transmitting uplink transmissions.

In some aspects, the transmission power may be based on the single carrier maximum power for the first carrier based on a condition that the non-overlapping uplink transmission on the first carrier does not overlap in time with an additional transmission on the uplink-capable secondary carrier.

In some aspects, the transmission power of the non-overlapping uplink transmission may be further based on a MTPL of the UE.

In some aspects, the single carrier maximum power for the first carrier may be based on a maximum allowable transmit power for the first carrier as supported by the UE and an uplink transmission power constraint for the first carrier.

In some aspects, the single carrier maximum power for the first carrier may be determined as a minimum of the maximum allowable transmit power for the first carrier as supported by the UE and the uplink transmission power constraint for the first carrier.

At 1025, the UE may transmit two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier. In some aspects, 1020 and/or 1025 may be performed by the ULCA component 198, the transceiver 1222, and/or the antenna 1280 in FIG. 12. FIGS. 7, 8, and 9 illustrate example aspects in connection with a UE transmitting uplink transmissions.

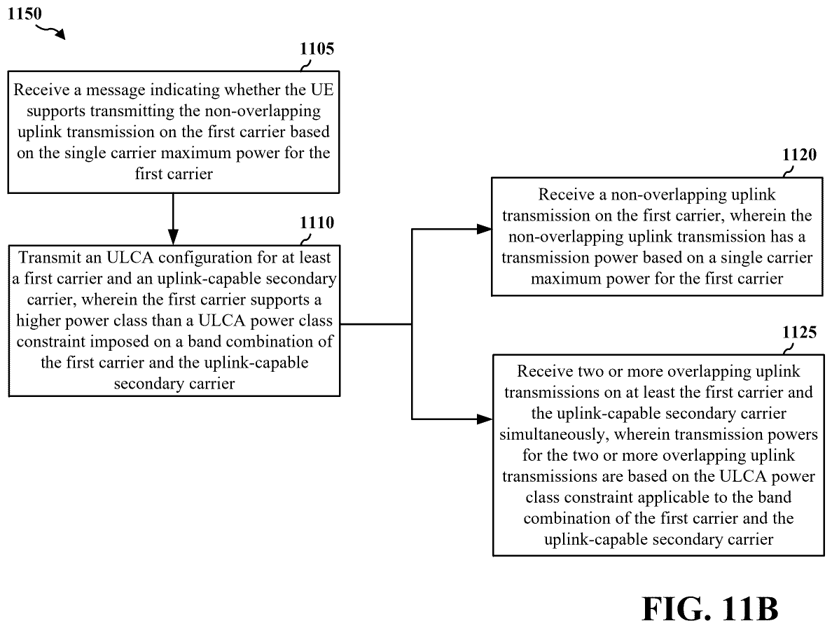

FIG. 11A is a flow chart 1100 of methods of wireless communication at a UE, in accordance with various aspects of the present disclosure. The network node may correspond to the base station 102 in aggregation and/or by one or more components (e.g., such as a CU 110, a DU 130, and/or an RU 140) in FIG. 1, the base station 310 in aggregation and/or by one or more components in FIG. 3, the network node 904 in FIG. 9, or the network entity 1302 in the hardware implementation of FIG. 13. In some aspects, the network node may also correspond to a network entity in the core network 120 in FIG. 1. The method improves the ULCA performance, reduces power restrictions under certain conditions, and enhances the connection stability, particularly in scenarios such as cell-edge conditions.

At 1110, the network node may transmit a ULCA configuration for at least a first carrier and an uplink-capable secondary carrier, where\n the first carrier supports a higher power class than a ULCA power class constraint imposed on a band combination of the first carrier and the uplink-capable secondary carrier. In some aspects, 1110 may be performed by the ULCA component 199 in FIG. 13. FIG. 9 illustrates an example of a network node providing an ULCA configuration, at 910.

At 1120, the network node may receive a non-overlapping uplink transmission on the first carrier, where the non-overlapping uplink transmission has a transmission power based on a single carrier maximum power for the first carrier. In some aspects, 1120 may be performed by the ULCA component 199 in FIG. 13. The transmission may include various aspects described in connection with any of FIGS. 7-9, for example.

FIG. 11B is a flow chart 1150 of methods of wireless communication at a UE, in accordance with various aspects of the present disclosure. The network node may correspond to the base station 102 in aggregation and/or by one or more components (e.g., such as a CU 110, a DU 130, and/or an RU 140) in FIG. 1, the base station 310 in aggregation and/or by one or more components in FIG. 3, the network node 904 in FIG. 9, or the network entity 1302 in the hardware implementation of FIG. 13. In some aspects, the network node may also correspond to a network entity in the core network 120 in FIG. 1. The method improves the ULCA performance, reduces power restrictions under certain conditions, and enhances the connection stability, particularly in scenarios such as cell-edge conditions. Some aspects of FIG. 11B may be similar to the aspects of FIG. 11A and are shown with the same reference number.

At 1105, the network node may receive a message indicating whether the UE supports transmitting the non-overlapping uplink transmission on the first carrier based on the single carrier maximum power for the first carrier. In some aspects, message may be indicated in a RRC IE. In some aspects, 1105 may be performed by the ULCA component 199 in FIG. 13. FIG. 9 illustrates an example of a network node receiving an indication, at 906.

At 1110, the network node may transmit a ULCA configuration for at least a first carrier and an uplink-capable secondary carrier, where the first carrier supports a higher power class than a ULCA power class constraint imposed on a band combination of the first carrier and the uplink-capable secondary carrier. In some aspects, 1110 may be performed by the ULCA component 199 in FIG. 13. FIG. 9 illustrates an example of a network node providing an ULCA configuration, at 910.

At 1120, the network node may receive a non-overlapping uplink transmission on the first carrier, where the non-overlapping uplink transmission has a transmission power based on a single carrier maximum power for the first carrier. In some aspects, 1120 may be performed by the ULCA component 199 in FIG. 13.

In some aspects, the transmission power may be based on the single carrier maximum power for the first carrier based on a condition that the non-overlapping uplink transmission on the first carrier does not overlap in time with an additional transmission on the uplink-capable secondary carrier.

In some aspects, the transmission power of the non-overlapping uplink transmission may be further based on a MTPL of the UE.

In some aspects, the single carrier maximum power for the first carrier may be based on a maximum allowable transmit power for the first carrier as supported by the UE and an uplink transmission power constraint for the first carrier.

In some aspects, the single carrier maximum power for the first carrier may be determined as a minimum of the maximum allowable transmit power for the first carrier as supported by the UE and the uplink transmission power constraint for the first carrier.

At 1125, the network node may receive two or more overlapping uplink transmissions on at least the first carrier and the uplink-capable secondary carrier simultaneously, where transmission powers for the two or more overlapping uplink transmissions are based on the ULCA power class constraint applicable to the band combination of the first carrier and the uplink-capable secondary carrier. In some aspects, 1125 may be performed by the ULCA component 199 in FIG. 13. The transmission may include various aspects described in connection with any of FIGS. 7-9, for example.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive a ULCA configuration for at least a first carrier and an uplink-capable secondary carrier, where the first carrier supports a higher power class than a ULCA power class constraint imposed on a band combination of the first carrier and the uplink-capable secondary carrier, and transmit a non-overlapping uplink transmission on the first carrier, where the non-overlapping uplink transmission has a transmission power based on a single carrier maximum power for the first carrier. The component 198 and/or the apparatus 1204 may be further configured to perform any of the aspects described in connection with the flowcharts in FIGS. 8, 10A, and/or 10B, and/or performed by the UE in the communication flow in FIG. 9. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for transmitting a message indicating whether the UE supports transmitting the non-overlapping uplink transmission on the first carrier based on the single carrier maximum power for the first carrier, means for receiving an ULCA configuration for at least a first carrier and an uplink-capable secondary carrier, wherein the first carrier supports a higher power class than a ULCA power class constraint imposed on a band combination of the first carrier and the uplink-capable secondary carrier, means for transmitting a non-overlapping uplink transmission on the first carrier, wherein the non-overlapping uplink transmission has a transmission power based on a single carrier maximum power for the first carrier, and means for transmitting two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier. The apparatus 1204 may further include means for performing any of the aspects described in connection with the flowcharts in FIGS. 8, 10A, and/or 10B, and/or performed by the UE in the communication flow in FIG. 9. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit an ULCA configuration for at least a first carrier and an uplink-capable secondary carrier, where the first carrier supports a higher power class than a ULCA power class constraint imposed on a band combination of the first carrier and the uplink-capable secondary carrier, and receive a non-overlapping uplink transmission on the first carrier, where the non-overlapping uplink transmission has a transmission power based on a single carrier maximum power for the first carrier. The component 199 and/or the network entity may be further configured to perform any of the aspects described in connection with the flowcharts in 11A, and/or 11B, and/or performed by the network node in the communication flow in FIG. 9. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for receiving a message indicating whether the UE supports transmitting the non-overlapping uplink transmission on the first carrier based on the single carrier maximum power for the first carrier, means for transmitting an ULCA configuration for at least a first carrier and an uplink-capable secondary carrier, wherein the first carrier supports a higher power class than a ULCA power class constraint imposed on a band combination of the first carrier and the uplink-capable secondary carrier, means for receiving a non-overlapping uplink transmission on the first carrier, wherein the non-overlapping uplink transmission has a transmission power based on a single carrier maximum power for the first carrier, and means for receiving two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier. The network entity may further include means for performing any of the aspects described in connection with the flowcharts in 11A, and/or 11B, and/or performed by the network node in the communication flow in FIG. 9. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

The improved ULCA configuration allows the UE to fully utilize the single-carrier maximum power when transmitting only on a signal active carrier, rather than being unnecessarily constrained by the lower ULCA power class limit intended for multiple simultaneously active carriers.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising receiving a ULCA configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and transmitting a non-overlapping uplink transmission on the first carrier, wherein the non-overlapping uplink transmission has a transmission power based on a single carrier maximum power for the first carrier.

Aspect 2 is the method of aspect 1, wherein the transmission power is based on the single carrier maximum power for the first carrier based on a condition that the non-overlapping uplink transmission on the first carrier does not overlap in time with an additional transmission on the uplink-capable secondary carrier.

Aspect 3 is the method of aspect 1 or 2, wherein the transmission power of the non-overlapping uplink transmission is further based on a maximum transmit power limit (MTPL) of the UE.

Aspect 4 is the method of any of aspects 1 to 3, wherein the single carrier maximum power for the first carrier is based on a maximum allowable transmit power for the first carrier as supported by the UE and an uplink transmission power constraint for the first carrier.

Aspect 5 is the method of aspect 1 to 4, wherein the single carrier maximum power for the first carrier is determined as a minimum of the maximum allowable transmit power for the first carrier as supported by the UE and the uplink transmission power constraint for the first carrier.

Aspect 6 is the method of any of aspects 1 to 5, further comprising transmitting two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.

Aspect 7 is the method of any of aspects 1 to 6, further comprising: transmitting a message indicating whether the UE supports transmitting the non-overlapping uplink transmission on the first carrier based on the single carrier maximum power for the first carrier.

Aspect 8 is the method of any of aspects 1 to 7, wherein the message is indicated in a radio resource control (RRC) information element (IE).

Aspect 9 is an apparatus for wireless communication at UE, comprising: at least one memory; and at least one processor coupled to the at least one memory, the at least one processor, individually or in any combination, is configured to perform the method of any of aspects 1 to 8.

Aspect 10 is an apparatus for wireless communication at a UE, comprising means for performing each step in the method of any of aspects 1 to 8.

Aspect 11 is the apparatus of any of aspects 1 to 8, further comprising a transceiver configured to receive or to transmit in association with the method of any of aspects 1 to 8.

Aspect 12 is a computer-readable medium (e.g., a non-transitory computer-readable medium) storing computer executable code at a UE, the code when executed by at least one processor causes the at least one processor to perform the method of any of aspects 1 to 8.

Aspect 13 is a method of wireless communication at a network node, comprising transmitting, to a user equipment (UE), a ULCA configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and receiving, from the UE, a non-overlapping uplink transmission on the first carrier, wherein the non-overlapping uplink transmission has a transmission power based on a single carrier maximum power for the first carrier.

Aspect 14 is the method of aspect 13, wherein the transmission power is based on the single carrier maximum power for the first carrier based on a condition that the non-overlapping uplink transmission on the first carrier does not overlap in time with an additional transmission on the uplink-capable secondary carrier.

Aspect 15 is the method of aspect 13 or 14, wherein the transmission power of the non-overlapping uplink transmission is further based on a maximum transmit power limit (MTPL) of the UE.

Aspect 16 is the method of any of aspects 13 to 15, wherein the single carrier maximum power for the first carrier is based on a maximum allowable transmit power for the first carrier as supported by the UE and an uplink transmission power constraint for the first carrier.

Aspect 17 is the method of aspect 13 to 16, wherein the single carrier maximum power for the first carrier is determined as a minimum of the maximum allowable transmit power for the first carrier as supported by the UE and the uplink transmission power constraint for the first carrier.

Aspect 18 is the method of any of aspects 13 to 16, further comprising receiving two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.

Aspect 19 is the method of any of aspects 13 to 18, further comprising receiving a message indicating whether the UE supports transmitting the non-overlapping uplink transmission on the first carrier based on the single carrier maximum power for the first carrier.

Aspect 20 is the method of any of aspects 13 to 19, wherein the message is indicated in a radio resource control (RRC) information element (IE).

Aspect 21 is an apparatus for wireless communication at UE, comprising: at least one memory; and at least one processor coupled to the at least one memory, the at least one processor, individually or in any combination, is configured to perform the method of any of aspects 13 to 20.

Aspect 22 is an apparatus for wireless communication at a UE, comprising means for performing each step in the method of any of aspects 13 to 20.

Aspect 23 is the apparatus of any of aspects 13 to 20, further comprising a transceiver configured to receive or to transmit in association with the method of any of aspects 13 to 20.

Aspect 24 is a computer-readable medium (e.g., a non-transitory computer-readable medium) storing computer executable code at a UE, the code when executed by at least one processor causes the at least one processor to perform the method of any of aspects 13 to 20.

What is claimed is:

1. An apparatus for wireless communication at a user equipment (UE), comprising:
memory; and
at least one processor coupled to the memory and, based at least in part on information stored in the memory, the at least one processor is configured to:
receive an uplink carrier aggregation (ULCA) configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and
transmit a non-overlapping uplink transmission on the first carrier,
wherein the non-overlapping uplink transmission has a transmission power based on a single carrier maximum power for the first carrier.

2. The apparatus of claim 1, wherein the transmission power is based on the single carrier maximum power for the first carrier based on a condition that the non-overlapping uplink transmission on the first carrier does not overlap in time with an additional transmission on the uplink-capable secondary carrier.

3. The apparatus of claim 1, wherein the transmission power of the non-overlapping uplink transmission is further based on a maximum transmit power limit (MTPL) of the UE.

4. The apparatus of claim 1, wherein the single carrier maximum power for the first carrier is based on a maximum allowable transmit power for the first carrier as supported by the UE and an uplink transmission power constraint for the first carrier.

5. The apparatus of claim 4, wherein the single carrier maximum power for the first carrier is determined as a minimum of the maximum allowable transmit power for the first carrier as supported by the UE and an uplink transmission power class constraint for the first carrier.

6. The apparatus of claim 1, wherein the at least one processor is configured to:
transmit two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.

7. The apparatus of claim 1, wherein the at least one processor is configured to:
transmit a message indicating whether the UE supports transmitting the non-overlapping uplink transmission on the first carrier based on the single carrier maximum power for the first carrier.

8. The apparatus of claim 7, wherein to transmit the message indicating whether the UE supports transmitting the non-overlapping uplink transmission on the first carrier based on the single carrier maximum power for the first carrier, the at least one processor is configured to:
transmit a radio resource control (RRC) information element (IE).

9. An apparatus for wireless communication at a network node, comprising:
memory; and
at least one processor coupled to the memory and, based at least in part on information stored in the memory, the at least one processor is configured to:
transmit, to a user equipment (UE), an uplink carrier aggregation (ULCA) configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and
receive, from the UE, a non-overlapping uplink transmission on the first carrier, wherein the non-overlapping uplink transmission has a transmission power based on a single carrier maximum power for the first carrier.

10. The apparatus of claim 9, wherein the transmission power is based on the single carrier maximum power for the first carrier based on a condition that the non-overlapping uplink transmission on the first carrier does not overlap in time with an additional transmission on the uplink-capable secondary carrier.

11. The apparatus of claim 9, wherein the transmission power of the non-overlapping uplink transmission is further based on a maximum transmit power limit (MTPL) of the UE.

12. The apparatus of claim 9, wherein the single carrier maximum power for the first carrier is based on a maximum allowable transmit power for the first carrier as supported by the UE and an uplink transmission power constraint for the first carrier.

13. The apparatus of claim 12, wherein the single carrier maximum power for the first carrier is determined as a minimum of the maximum allowable transmit power for the first carrier as supported by the UE and an uplink transmission power class constraint for the first carrier.

14. The apparatus of claim 9, wherein the at least one processor is configured to:
receive two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.

15. The apparatus of claim 9, wherein the at least one processor is configured to:
receive a message indicating whether the UE supports transmitting the non-overlapping uplink transmission on the first carrier based on the single carrier maximum power for the first carrier.

16. The apparatus of claim 15, wherein to receive the message indicating whether the UE supports transmitting the non-overlapping uplink transmission on the first carrier based on the single carrier maximum power for the first carrier, the at least one processor is configured to:
receive a radio resource control (RRC) information element (IE).

17. A method for wireless communication at a user equipment (UE), comprising:
receiving an uplink carrier aggregation (ULCA) configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and
transmitting a non-overlapping uplink transmission on the first carrier, wherein the non-overlapping uplink transmission has a transmission power based on a single carrier maximum power for the first carrier.

18. The method of claim 17, wherein the transmission power is based on the single carrier maximum power for the first carrier based on a condition that the non-overlapping uplink transmission on the first carrier does not overlap in time with an additional transmission on the uplink-capable secondary carrier.

19. The method of claim 17, wherein the transmission power of the non-overlapping uplink transmission is further based on a maximum transmit power limit (MTPL) of the UE.

20. The method of claim 17, wherein the single carrier maximum power for the first carrier is based on a maximum allowable transmit power for the first carrier as supported by the UE and an uplink transmission power constraint for the first carrier.

21. The method of claim 20, wherein the single carrier maximum power for the first carrier is determined as a minimum of the maximum allowable transmit power for the first carrier as supported by the UE and an uplink transmission power class constraint for the first carrier.

22. The method of claim 17, further comprising:
transmitting two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.

23. The method of claim 17, further comprising:
transmitting a message indicating whether the UE supports transmitting the non-overlapping uplink transmission on the first carrier based on the single carrier maximum power for the first carrier.

24. The method of claim 23, wherein the message is indicated in a radio resource control (RRC) information element (IE).

25. A method for wireless communication at a network node, comprising:
transmitting, to a user equipment (UE), an uplink carrier aggregation (ULCA) configuration for at least a first carrier and an uplink-capable secondary carrier, wherein at least one of the first carrier or the uplink-capable secondary carrier supports a higher power class than a ULCA power class constraint imposed on a band combination of the first carrier and the uplink-capable secondary carrier; and
receiving, from the UE, a non-overlapping uplink transmission on the first carrier, wherein the non-overlapping uplink transmission has a transmission power based on a single carrier maximum power for the first carrier.

26. The method of claim 25, wherein the transmission power is based on the single carrier maximum power for the first carrier based on a condition that the non-overlapping uplink transmission on the first carrier does not overlap in time with an additional transmission on the uplink-capable secondary carrier.

27. The method of claim 25, wherein the transmission power of the non-overlapping uplink transmission is further based on a maximum transmit power limit (MTPL) of the UE.

28. The method of claim 25, wherein the single carrier maximum power for the first carrier is based on a maximum allowable transmit power for the first carrier as supported by the UE and an uplink transmission power constraint for the first carrier.

29. The method of claim 28, wherein the single carrier maximum power for the first carrier is determined as a minimum of the maximum allowable transmit power for the first carrier as supported by the UE and an uplink transmission power class constraint for the first carrier.

30. The method of claim 25, further comprising:
receiving two or more overlapping uplink transmissions on at least the first carrier and the uplink-capable secondary carrier simultaneously, wherein transmission powers for the two or more overlapping uplink transmissions are based on the ULCA power class constraint applicable to the band combination of the first carrier and the uplink-capable secondary carrier.
